(19) United States
(12) Patent Application Publication
(10) Pub. No.: US 2021/0208781 A1
(43) Pub. Date: Jul. 8, 2021

(54) STORAGE CONTROL METHOD, STORAGE CONTROLLER, STORAGE DEVICE AND STORAGE SYSTEM

(71) Applicant: Shanghai Baigong Semiconductor Co., LTD., Shanghai (CN)

(72) Inventors: Ching Chang CHEN, Shanghai (CN); Nan YU, Shanghai (CN); Shijun LIU, Shanghai (CN); Gang CHEN, Shanghai (CN)

(73) Assignee: Shanghai Baigong Semiconductor Co., LTD., Shanghai (CN)

(21) Appl. No.: 16/610,514

(22) PCT Filed: Jan. 21, 2019
(86) PCT No.: PCT/CN2019/072541

§ 371 Date: Jun. 28, 2020

(30) Foreign Application Priority Data
Sep. 29, 2018 (CN) 201811147678.7

(51) Int. Cl. G06F 3/06; G06N 3/08

(52) U.S. Cl. CPC G06F 3/0604; G06F 3/0619; G06N 3/08; G06F 3/0659; G06F 3/0673; G06F 3/0629

(57) ABSTRACT

The present disclosure provides a storage control method, a storage controller, a storage device, and a storage system. The storage control method controls a storage behavior of a storage device, including: acquiring behavior information of the storage device; processing the behavior information through a deep learning algorithm to obtain a behavior parameter of the storage device; and adjusting an operation mode of the storage device according to the behavior parameter of the storage device. The present disclosure enhances the automatic adjustment operation algorithm of the storage device by means of deep self-learning to adapt to the different requirements of the complex system for the storage device, thereby achieving the storage device with the optimal read/write performance, the best reliability, and the lowest power consumption in accordance with the requirements of the system.

### CROSS REFERENCE TO RELATED APPLICATION

This is a Sect. 371 National Stage of PCT International Application No. PCT/CN2019/072541, filed on 21 Jan. 2019, which claims priority of a Chinese Patent Application No. 2018111476787 filed on 29 Sep. 2018, the contents of both applications hereby being incorporated by reference in their entireties for all purposes.

### BACKGROUND

### Field of Disclosure

The present disclosure belongs to the field of storage, and relates to a storage control method, a storage controller, a storage device, and a storage system.

### Description of Related Arts

With the continuous improvement of flash memory technology and the development of 3D TLC/QLC process, flash-memory-based storage devices have been gradually realized. The advantages of high capacity and low cost make such storage devices become a hot spot for application and research of big data and cloud storage unit in the future. However, since 3D TLC/QLC has very high original bit error rate, and has increased sensitivity to temperature and voltage, a more complicated algorithm mechanism is required for management.

In practical applications, different systems have different operating modes for storage devices, and have different requirements in performance, so no fixed algorithm of storage devices can adapt to a variety of different system applications. Therefore, customization is needed.

However, user behavior model requirements of intelligent network and artificial intelligence systems become complicated, the design of system architecture is more complicated and non-immobilized with the requirements of comprehensiveness and diversification. Storage devices customized to specific user behaviors become an investment in high cost and low applicability.

### SUMMARY OF THE PRESENT DISCLOSURE

The present disclosure provides a storage control method, a storage controller, a storage device, and a storage system for implementing a storage algorithm and device adaptive to various system applications.

The present disclosure provides a storage control method for controlling a storage behavior of a storage device. The storage control method includes: acquiring behavior information of the storage device; processing the behavior information through a deep learning algorithm to obtain a behavior parameter of the storage device; and adjusting an operation mode of the storage device according to the behavior parameter of the storage device.

In an embodiment of the present disclosure, the behavior information of the storage device includes user behavior information; a user of the storage device is a host system, and the user behavior information of the storage device includes: an instruction set sequence issued by the host system to the storage device; a read data amount, a read position, and a read range performed by the host system on the storage device; a write data amount, a write position, and a write range performed by the host system on the storage device; or/and a data stream behavior when the host system performs writing and reading data on the storage device. The data stream behavior includes: a busy time for transferring data, an idle time for suspending data transfer of a data bus of the host system, and a busy time and an idle time of a data bus of a storage element.

Processing the user behavior information through the deep learning algorithm to obtain a user behavior parameter of the storage device includes: processing the instruction set sequence by using the deep learning algorithm to obtain a command set and a command sequence commonly used in the host system; processing the read position through the deep learning algorithm to obtain a ratio of sequential read commonly used in the host system to random read; processing the write position through the deep learning algorithm to obtain a ratio of sequential write commonly used in the host system to random write; processing the write data amount and the read data amount through the deep learning algorithm to obtain a data write/read amount statistics table commonly used in the host system; processing the write position and the read position through the deep learning algorithm to obtain a data write/read start logical position statistics table commonly used in the host system; processing the write range and the read range through the deep learning algorithm to obtain a data write/read range statistics table commonly used in the host system; and processing the write range and the read range through the deep learning algorithm to obtain a data write/read range statistics table commonly used in the host system.

The user behavior parameter of the storage device includes: the command set and the command sequence commonly used in the host system, the ratio of sequential read to random read commonly used in the host system, the ratio of sequential write to random write commonly used in the host system, the data write/read amount statistics table commonly used in the host system, the data write/read start logical position statistics table commonly used in the host system, the data write/read range statistics table commonly used in the host system, or/and the data stream behavior statistics table commonly used in the host system.

In an embodiment of the present disclosure, adjusting an operation mode of the storage device according to the user behavior parameter of the storage device includes: the storage device includes a storage controller and the storage element; adjusting a data write/read management mechanism for the storage device; adjusting an allocation strategy of a data/control signal bus usage right; adjusting an allocation and placement strategy of data blocks in the storage element; adjusting a command processing priority strategy; adjusting a management strategy for data buffer; adjusting a writing or reading rate to the storage element; adjusting an operating frequency of the storage controller; adjusting a start timing and a behavior decision of a background operation; or/and adjusting a power management start timing and mode.

In an embodiment of the present disclosure, a user of the storage device is a host system; the behavior information of the storage device comprises system power behavior information, the system power behavior information comprises: a power supply voltage, a power management mode, a power-off behavior, and power stability of the storage device performed by the host system. Processing the system power behavior information though the deep learning algorithm to obtain a system power behavior parameter of the storage device includes: processing the power supply voltage through the deep learning algorithm to obtain a voltage range; processing the power management mode through the deep learning algorithm to obtain a sleep mode statistics table; processing the power-off behavior through the deep learning algorithm to obtain a safe power-off program mode and an unsafe power-off statistic; the system power behavior parameter comprises: the voltage range, the sleep mode statistics table, the safe power-off program mode or/and the unsafe power-off statistic.

In an embodiment of the present disclosure, adjusting the operating mode of the storage device according to the system power behavior parameter includes: adjusting a management mechanism of power management and data security protection of the storage device; adjusting a start timing and a behavior decision of a background operation; or/and adjusting a data buffer mechanism and a final storage block configuration decision of the storage element.

In an embodiment of the present disclosure, a user of the storage device is a host system; the behavior information of the storage device comprises working environment temperature behavior information, the working environment temperature behavior information comprises: a working environment temperature of the storage device when executing a command of the host system; processing the working environment temperature behavior information through a deep learning algorithm to obtain a working environment temperature behavior parameter of the storage device.

In an embodiment of the present disclosure, adjusting the operating mode of the storage device according to the working environment temperature behavior parameter includes: adjusting a power management mechanism of the storage device; adjusting a writing or reading rate to the storage element; adjusting an operating frequency of the storage controller; adjusting a start timing and a behavior decision of a background operation; or/and adjusting a power management start timing and mode.

In an embodiment of the present disclosure, the behavior information of the storage device includes storage element behavior information, the storage element behavior information includes: a number of the error code and probability of error code occurrence of a read block position of the storage device when reading data; a behavior mode of hard decoding and soft decoding when the error code of the read block position of the storage device occurs when reading data; a probability of rereading data and a success probability of parameters in a rereading table of the storage element when reading data; a writing failure rate of a write block position of the storage device when writing data; an erasing failure rate of an erase block position of the storage device when deleting data; timing of a control signal and a data signal when data is written to the storage element; the timing includes a clock rate, a slew rate, and a delay time; timing of the control signal and the data signal when reading data of the storage element; the timing includes a clock rate, a slew rate, and a delay time; or/and an operating voltage of the storage element.

In an embodiment of the present disclosure, processing the storage element behavior information through the deep learning algorithm to obtain a storage element behavior parameter includes: processing the storage element behavior information through the deep learning algorithm to obtain an optimal timing of the control signal and the data signal when the data is written into the storage element, the optimal timing includes a clock rate, a slew rate, and a delay time; processing the storage element behavior information through the deep learning algorithm to obtain an optimal timing of the control signal and the data signal when reading data of the storage element, the optimal timing includes a clock rate, a slew rate, and a delay time; processing the storage element behavior information through the deep learning algorithm to obtain an optimal swing level of the control signal and the data signal; processing the writing failure rate, the erasing failure rate, the probability of rereading the table, and the number of the error code and probability of the error code occurrence through the deep learning algorithm, to obtain a storage block health status statistics table in the storage element. The storage element behavior parameter of the storage device includes: the optimal timing of the control signal and the data signal when the data is written into the storage element, the optimal timing of the control signal and the data signal when reading the storage element, the optimal swing level of the control signal and the data signal, or/and the storage block health status statistics table in the storage element.

In an embodiment of the present disclosure, adjusting the operating mode of the storage device according to the storage element behavior parameter of the storage device includes: adjusting driving management mechanism for storage element in the storage device according to the storage element behavior parameter of the storage device; adjusting a data write/read management mechanism for the storage device; adjusting a data block allocation and placement strategy of the storage element; adjusting a management strategy for data buffer; adjusting a writing or reading rate to the storage element; or/and adjusting a start timing and a behavior decision of a background operation.

In an embodiment of the present disclosure, the deep learning algorithm is a learning method operated by a deep neural network, and the learning method operated by the deep neural network includes: inputting the behavior information through an input layer; performing deep learning processing by processing the behavior information of the storage device through at least one intermediate processing layer, including: analyzing features of interested events, taking the analyzed features as parameters of the input layer, generating output parameters by an output layer through a back propagation algorithm, and updating weight values of nodes in the intermediate processing layers; outputting processed output parameters through the output layer, i.e. the behavior parameters of the storage device.

The present disclosure further provides a storage controller for controlling a storage behavior of a storage device. The storage controller includes: a first interface, a second interface, and a processing module. The first interface is in communication connection with a user interface of the storage device, and acquires user behavior information of the storage device. The second interface is in communication connection with a storage element of the storage device, and acquires storage element behavior information of the storage device. The processing module is in communication connection with the first interface and the second interface respectively, processes behavior information of the storage device through a deep learning algorithm, obtains a behavior parameter of the storage device, and adjusts an operation mode of the storage device through the behavior parameter of the storage device.

The present disclosure further provides a storage device, including: a user interface in communication connection with a user device, receiving a storage instruction of the user device; at least one storage element for storing data; a power module for supplying power; a storage controller in communication connection with the user interface, the storage element, and the power module respectively, the storage controller includes: a first interface in communication with the user interface to acquire user behavior information of the storage device; a second interface in communication connection with the storage element, acquiring storage element behavior information of the storage device; a processing module in communication connection with the first interface and the second interface respectively, processing behavior information of the storage device through a deep learning algorithm, obtaining a behavior parameter of the storage device, and adjusting an operation mode of the storage device through the behavior parameter of the storage device.

The present disclosure further provides a storage system, including: a user device, controlling a storage device to perform a storage operation; the user device comprises a host system; the storage device includes: a user interface in communication connection with the user device, receiving a storage instruction of the user device; at least one storage element for storing data; a power module for supplying power; a storage controller in communication connection with the user interface, the storage element, and the power module respectively, the storage controller includes: a first interface in communication connection with the user interface to acquire user behavior information of the storage device; a second interface in communication connection with the storage element, acquiring storage element behavior information of the storage device; a processing module in communication connection with the first interface and the second interface respectively, processing behavior information of the storage device through a deep learning algorithm, obtaining a behavior parameter of the storage device, and adjusting an operation mode of the storage device through the behavior parameter of the storage device.

As described above, the storage control method, the storage controller, the storage device, and the storage system of the present disclosure have the following beneficial effects:

The present disclosure enhances the automatic adjustment operation algorithm of the storage device by means of deep self-learning to adapt to the different requirements of the complex system for the storage device, thereby achieving the storage device with the optimal read/write performance, the best reliability, and the lowest power consumption in accordance with the requirements of the system.

### BRIEF DESCRIPTION OF THE DRAWINGS

FIG. 1A is a schematic diagram showing an exemplary process of a storage control method according to an embodiment of the present disclosure.

FIG. 1B is a schematic diagram showing an exemplary application scenario of the storage control method according to an embodiment of the present disclosure.

FIG. 1C is a schematic diagram showing another exemplary application scenario of the storage control method according to an embodiment of the present disclosure.

FIG. 1D is a schematic diagram showing an exemplary structure of the storage control method according to an embodiment of the present disclosure.

FIG. 1E is a schematic diagram showing an exemplary process of a deep learning algorithm in the storage control method according to an embodiment of the present disclosure.

FIG. 1F is a schematic diagram showing an exemplary model of a neural network of the deep learning algorithm in the storage control method according to an embodiment of the present disclosure.

FIG. 1G is a schematic diagram showing an exemplary structure of a deep neural network architecture implementing a deep learning algorithm of the storage control method according to an embodiment of the present disclosure, the deep neural network architecture adjusts the storage control operation mechanism.

FIG. 2 is a schematic diagram showing an exemplary structure of a storage controller according to an embodiment of the present disclosure.

FIG. 3 is a schematic diagram showing an exemplary structure of a storage device according to an embodiment of the present disclosure.

FIG. 4 is a schematic diagram showing an exemplary structure of a storage system according to an embodiment of the present disclosure.

### DETAILED DESCRIPTION OF THE PREFERRED EMBODIMENTS

The embodiments of the present disclosure will be described below. Those skilled in the art can easily understand other advantages and effects of the present disclosure according to contents disclosed by the specification. The present disclosure can also be implemented or applied through other different specific implementation modes. Various modifications or changes can also be made to all details in the specification based on different points of view and applications without departing from the spirit of the present disclosure. It needs to be stated that the following embodiments and the features in the embodiments can be combined with one another under the situation of no conflict.

It needs to be stated that the drawings provided in the following embodiments are just used for schematically describing the basic concept of the present disclosure, thus only illustrating components only related to the present disclosure and are not drawn according to the numbers, shapes and sizes of components during actual implementation, the configuration, number and scale of each component during actual implementation thereof may be freely changed, and the component layout configuration thereof may be more complicated.

The present disclosure discloses a method for improving the read/write performance, stability and reliability of a storage device, and reducing power consumption by using a deep self-learning algorithm. The method records behaviors the system performed to the storage device, such as an instruction set, an instruction sequence, a data size, a data flow pattern, a storage frequency, a power supply status, etc. These behaviors are designated for the storage device by the system during the operation of the system. Deep calculations, comparisons, and analysis are performed on collected behavior information. Through this deep learning (i.e., observing and analyzing) “user behaviors”, the control method of the storage device itself is adapted to optimize the performance, reliability, compatibility, and power consumption of the storage device in the entire system.

The present disclosure analyzes the system operation behavior pattern by means of the self-deep learning of the storage device, and gradually adapts and optimizes the working mode of the storage device itself to adapt to the overall system operation behavior, thereby improving the overall system efficiency, reliability, and compatibility of the entire system, and reducing the power consumption.

The present disclosure enhances the automatic adjustment operation algorithm of the storage device by means of deep self-learning, in order to adapt to the different requirements of the complex system for the storage device, thereby achieving the storage device with the optimal read/write performance, the best reliability, and the lowest power consumption in accordance with the requirements of the system. The present disclosure solves the problem of high cost and low applicability caused by customized storage devices according to requirements of different systems.

In the present disclosure, a Host System refers to a device that uses a flash storage device to storage, i.e. read data, information, an executable program, an operating system, and the like, such as a server, a notebook, a mobile phone, a smart home appliance, a security system, a car, etc.

The Flash Storage Device refers to any data storage device that the main body is NAND Flash Array or a storage element, a flash control chip, or/and DRAM Array or a memory element. The DRAM Array is a selective element, and may or may not be included in the device. For example, SSD, eMMC, UFS, UFD, and SD are examples of flash storage devices.

A Storage System Protocol refers to a protocol the host system communicating with the flash storage device, such as SATA, PCIe, eMMC, UFS, etc.

Hardware is formed in an integrated circuit by a logic circuit or an analog circuit or a transistor (FET) to implement its defined functions.

Firmware refers to a program code written in a program code, and compiled by a compiler, so as to be executed by a CPU.

Flash Translation Layer (FTL) refers to the algorithm modules used to process the data write/read from the host system to the flash array in the firmware of the flash control chip.

A Neural Network (NN) refers to a method in the field of machine learning, which constructs a machine learning model by simulating the operation of the Neural Network in the human brain. The concept of the Neural Network is: a bunch of data X, each data has multiple eigenvalues (x1, x2, x3, x4), and the Weighting (W) of each layer in NN can determine the final Y (y1, y2, y3). The NN may have Multi-Layer Perception (MLP). More levels result in larger network, and the more parameters W are needed, so it takes more time to calculate the gradient.

Deep Learning refers to a Deep Neural Network (DNN), and its Hidden Layer has many levels. Each hidden layer means a filter has difference. Different features are filtered according to the conditional formula. The more hidden layers represent using filters with more styles. After the Back Propagation calculation, the weight (W) of different conditions for each node is obtained. The important node condition has higher weight. The less important node condition has lower weight. These node conditions with large W represent that the important components of X-->Y may be calculated by using these node conditions, i.e. the “features”. In each learning, the algorithm will automatically adjust the relevant weight (W) in the DNN, which is also the core point of the present disclosure automatically acquiring features through DNN. The newly acquired features will update the DNN through the algorithm. It is completely different from the current algorithm (the feature or parameter is defined by a predetermined program).

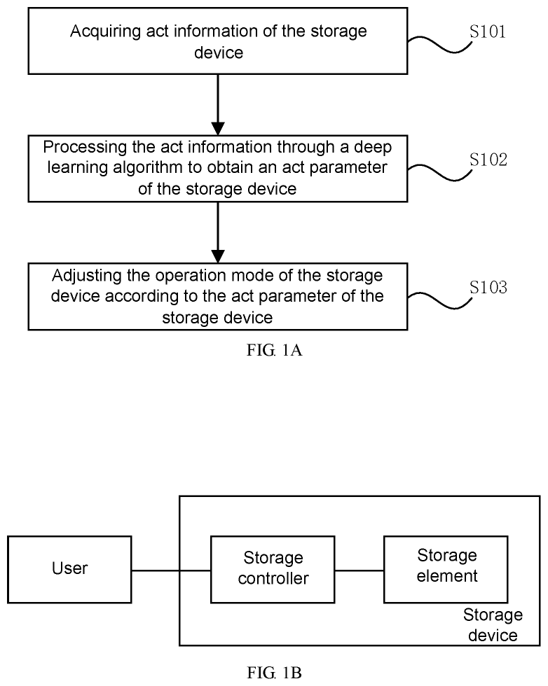

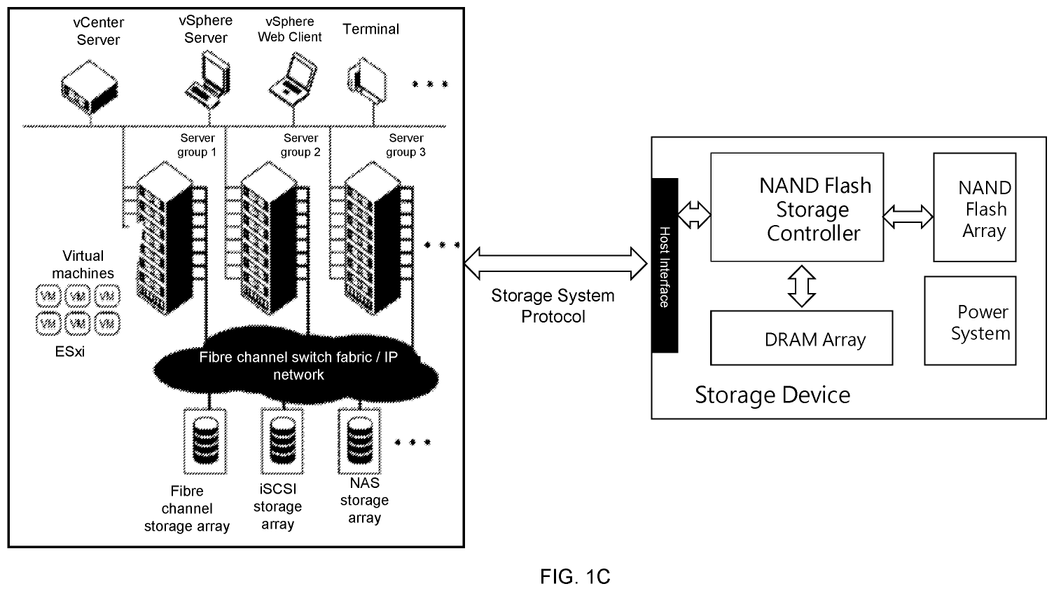

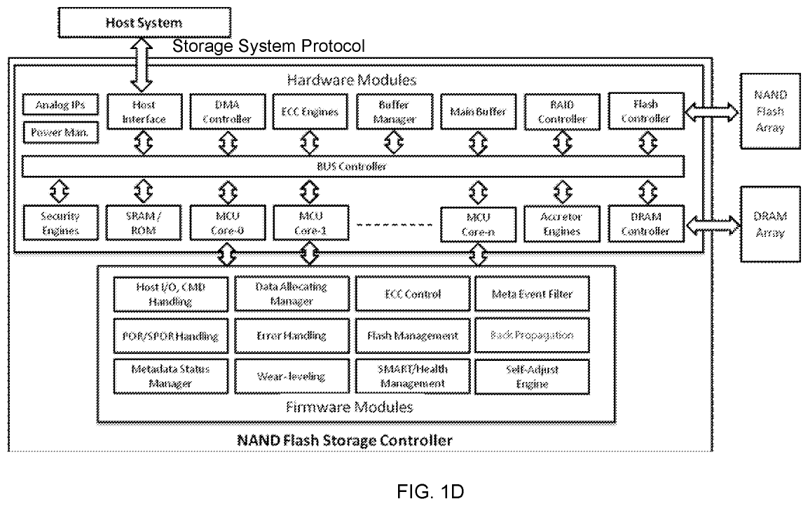

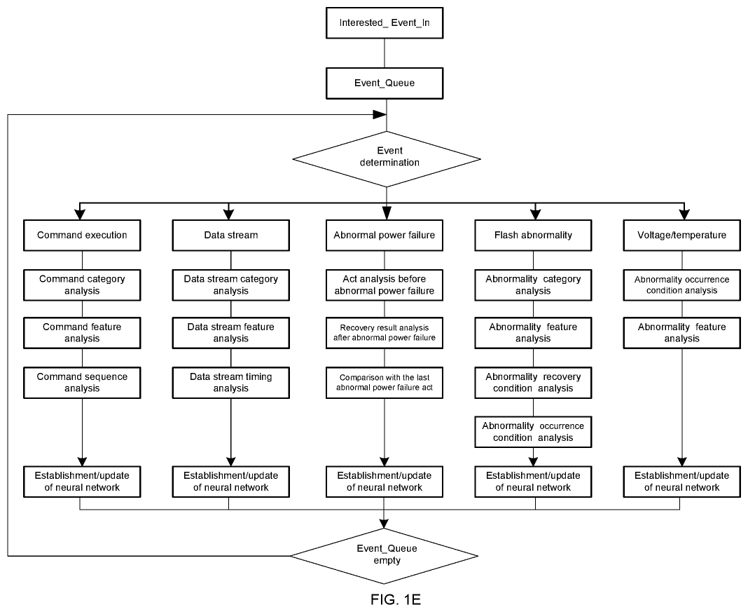

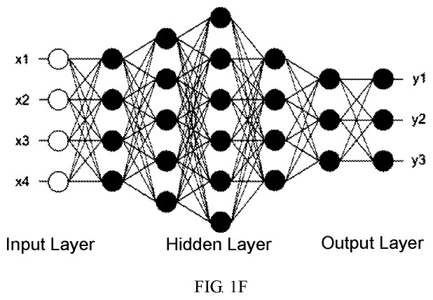

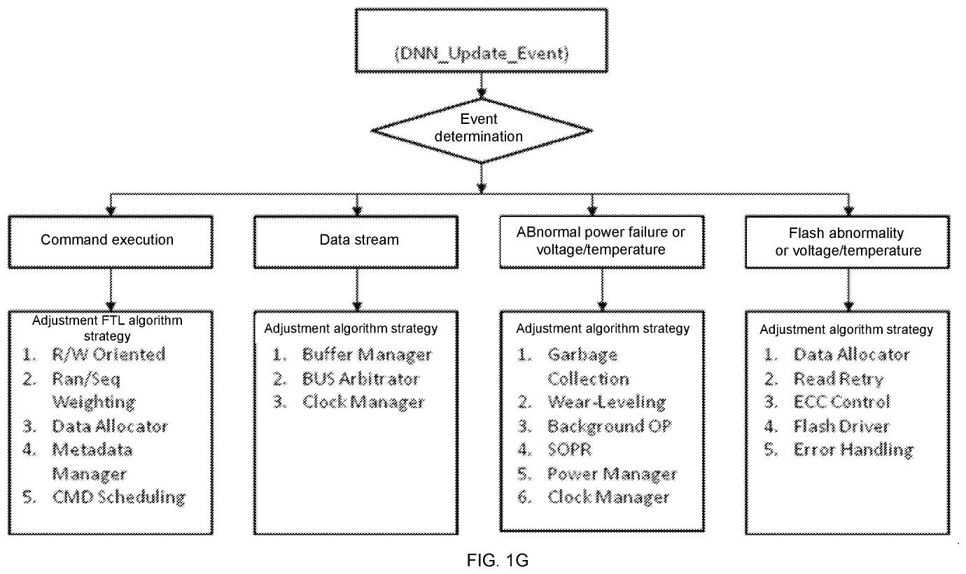

Referring to FIG. 1A, an embodiment of the present disclosure provides a storage control method for controlling a storage behavior of a storage device. The storage control method includes:

S101. Acquiring behavior information of the storage device. The behavior information includes user behavior information, system power behavior information, work environment temperature behavior information, or/and storage element behavior information. The behavior information may be stored in a controller memory of the storage device, or stored in a flash memory of the storage device, or stored in a memory of the storage device.

S102. Processing the behavior information through a deep learning algorithm to obtain a behavior parameter of the storage device.

S103. Adjusting the operation mode of the storage device according to the behavior parameter of the storage device.

Further, after the execution of the operation S102 is finished, the behavior information stored in the memory may be completely or partially discarded, to release the memory space for storing new behavior information.

An embodiment of the present disclosure further provides an application of the storage control method, as shown in FIG. 1B.

In an embodiment of the present disclosure, a user of the storage device is a host system. The user behavior information includes: an instruction set sequence issued by the host system to the storage device; a read amount of data, a read position, and a read range performed by the host system on the storage device; a write amount of data, a write position, and a write range performed by the host system on the storage device; or/and a data stream behavior when the host system performs writing and reading data on the storage device. The data stream behavior includes: a busy time for transferring data, and an idle time for suspending data transfer of a data bus of the host system, and a busy time and an idle time of a data bus of a storage element. The read range refers to a range from the start read position to the termination read position. The write range refers to a range from the start write position to the termination write position.

Processing the user behavior information through the deep learning algorithm to obtain a user behavior parameter of the storage device includes: processing the instruction set sequence by using the deep learning algorithm to obtain a command set and a command sequence that commonly used in the host system; processing the read position through the deep learning algorithm to obtain a ratio of sequential read commonly used in the host system to random read; processing the write position through the deep learning algorithm to obtain a ratio of sequential write commonly used in the host system to random write; processing the write amount of data and the read amount of data through the deep learning algorithm to obtain a data write/read amount statistics table commonly used in the host system; processing the write position and the read position through the deep learning algorithm to obtain a data write/read start logical position statistics table commonly used in the host system; processing the write range and the read range through the deep learning algorithm to obtain a data write/read range statistics table that commonly used in the host system; processing the data stream behavior during writing and reading data to obtain a data stream behavior table commonly used in the host system.

The user behavior parameter of the storage device includes: the command set and the command sequence commonly used in the host system, the ratio of sequential read commonly used in the host system to random read, the ratio of sequential write to random write commonly used in the host system, the data write/read amount statistics table commonly used in the host system, the data write/read start logical position statistics table commonly used in the host system, the data write/read range statistics table commonly used in the host system, or/and the data stream behavior statistics table commonly used in the host system.

Adjusting an operation mode of the storage device according to the user behavior parameter of the storage device includes: the storage device includes a storage controller and the storage element; adjusting a data write/read management mechanism for the storage device; adjusting an allocation strategy of a data/control signal bus usage right; adjusting an allocation and placement strategy of data blocks in the storage element; adjusting a command processing priority strategy; adjusting a management strategy for data buffer; adjusting a writing or reading rate to the storage element; adjusting an operating frequency of the storage controller; adjusting a start timing and a behavior decision of a background operation; or/and adjusting a power management start timing and mode. The optimal mode for the overall operation of the host system and the storage device is implemented. The overall data write/read performance and reliability of the host system and the storage device are improved, and the power consumption is reduced. The background operation is a collection of various operations in the firmware module of the storage device, such as wear-leveling, Error handle, and the like.

When the controlled storage device is a flash storage device, an application scenario of the storage control method can be seen in FIGS. 1C-1D. Taking a user of a storage device (such as a flash storage device) is a host system (such as a Host) as an example, to implement the present disclosure, the following operations are required:

An instruction set sequence that the system is accustomed to is collected from the instruction set sequence issued by the Host to the flash storage device. The specific implementation manner includes: when receiving the executive command issued by the host, the flash storage device responds to the command and executes tasks required by the command according to the protocol standard, the flash storage device collects and analyzes the command behavior of Host.

From the write data behavior executed by the Host on the flash storage device, the write data amount, the write position, the write range, and the idle time between data and data commonly used in the system are collected. The specific implementation manner includes: when receiving the data that the host requests to write, the flash storage device responds to the command and execute writing task according to the protocol standard, the flash storage device collects and analyzes the behavior mode of the data transmitted by the Host.

From the behavior of reading data performed by the host on the flash storage device, the read data amount, the read position, and the read range commonly used in the system are collected. The specific implementation manner includes: when the data to be read by the Host has been ready, the flash storage device responds to the command and executes the reading task according to the protocol standard, the flash storage device collects and analyzes the behavior mode of the data read by the Host.

The storage device in the present disclosure includes, but is not limited to, a flash storage device. Any type of storage device is included in the scope of the storage device of the present disclosure. The user of the storage device in the present disclosure is not limited to the host system. Any device that controls the storage device belongs to the user scope of the storage device.

In an embodiment of the present disclosure, a user of the storage device is a host system; the behavior information of the storage device includes system power behavior information. The system power behavior information includes: a power supply voltage, a power management mode, a power-off behavior, and power stability of the storage device performed by the host system.

Obtaining a system power behavior parameter of the storage device by processing the system power behavior information though the deep learning algorithm includes: obtaining a voltage range by processing the power supply voltage through the deep learning algorithm. Processing the power management mode through the deep learning algorithm to obtain a sleep mode statistics table. Processing the power-off behavior through the deep learning algorithm to obtain a safe power-off program mode and an unsafe power-off statistic. The system power behavior parameter includes: the voltage range, the sleep mode statistics table, the safe power-off program mode or/and the unsafe power-off statistic.

Adjusting the operating mode of the storage device according to the system power behavior parameter includes: adjusting a management mechanism of power management and data security protection of the storage device; adjusting a start timing and a behavior decision of a background operation; or/and adjusting a data buffer mechanism and a final storage block configuration decision of the storage element. The optimal mode for the overall operation of the host system and the storage device is implemented. The overall reliability and stability of the host system and the storage device are improved.

When the controlled storage device is a flash storage device, an application of the storage control method is shown in FIGS. 1C-1E. Taking a user of a storage device (such as a flash storage device) is a host system (such as a Host) as an example, to implement the present disclosure, the following operations are required:

From the power behaviors performed by the Host on the flash storage device, a voltage level, a power management mode, a power-off behavior, and power stability commonly used in the system are collected. The specific implementation manner includes: the flash storage device monitors the voltage level, the power management mode, the power-off behavior, and the power stability commonly used in the Host, to collect and analyze the power behavior mode of the Host.

In an embodiment of the present disclosure, a user of the storage device is a host system. The behavior information of the storage device includes working environment temperature behavior information. The working environment temperature behavior information includes: a working environment temperature of the storage device in a process of executing a command of the host system.

When the controlled storage device is a flash storage device, an application scenario of the storage control method can be seen in FIG. 1E. Taking a user of a storage device (such as a flash storage device) is a host system (such as a Host) as an example, to implement the present disclosure, the following operations are performed: collecting and analyzing the temperature detected by the flash storage device itself during operation. The specific implementation manner includes: the flash storage device monitors the temperature during operation, collect and analyze the results.

Processing the working environment temperature behavior information through a deep learning algorithm to obtain a working environment temperature behavior parameter of the storage device.

Adjusting the operating mode of the storage device according to the working environment temperature behavior parameter includes: adjusting a power management mechanism of the storage device; adjusting a writing or reading rate to the storage element; adjusting a service frequency of the storage controller; adjusting a start timing and a behavior decision of a background operation; or/and adjusting a power management start timing and mode.

In an embodiment of the present disclosure, the behavior information of the storage device includes storage element behavior information. The storage element behavior information includes: a number of the error code and probability of error code occurrence of a read block position of the storage device when reading data; a behavior mode of hard decoding and soft decoding when the error code of the read block position of the storage device occurs when reading data; a probability of rereading data and a success probability of parameters in a rereading table of the storage element when reading data; a writing failure rate of a write block position of the storage device when writing data; an erasing failure rate of an erase block position of the storage device when deleting data; timing of a control signal and a data signal when data is written to the storage element; the timing includes a clock rate, a slew rate, and a delay time; timing of the control signal and the data signal when reading data of the storage element; the timing includes a clock rate, a slew rate, and a delay time; or/and an operating voltage of the storage element. The behavior information of the storage element may be stored in a controller memory of the storage device, or stored in a flash memory of the storage device, or stored in a memory of the storage device.

Obtaining a storage element behavior parameter by processing the storage element behavior information through the deep learning algorithm includes: processing the storage element behavior information through the deep learning algorithm to obtain an optimal timing of the control signal and the data signal when the data is written into the storage element, the optimal timing includes a clock rate, a slew rate, and a delay time; processing the storage element behavior information through the deep learning algorithm to obtain an optimal timing of the control signal and the data signal when reading data of the storage element, the optimal timing includes a clock rate, a slew rate, and a delay time; processing the storage element behavior information through the deep learning algorithm to obtain an optimal swing level of the control signal and the data signal; processing the writing data failure rate, the erasing data failure rate, the probability of rereading the table, the number of the error code and probability of the error code occurrence through the deep learning algorithm, to obtain a storage block health status statistics table in the storage element. The storage element behavior parameter of the storage device includes: the optimal timing of the control signal and the data signal when the data is written into the storage element, the optimal timing of the control signal and the data signal when reading the storage element, the optimal swing level of the control signal and the data signal, or/and the storage block health status statistics table in the storage element.

Adjusting the operating mode of the storage device according to the storage element behavior parameter of the storage device includes: adjusting the driving management mechanism for the storage element in the storage device according to the storage element behavior parameter of the storage device; adjusting a data write/read management mechanism for the storage device; adjusting a data block allocation and placement strategy of the storage element; adjusting a management strategy for data buffer; adjusting a writing or reading rate to the storage element; or/and adjusting a start timing and a behavior decision of a background operation. The optimal control mode for the storage of the storage element of the storage device is implemented. The reliability and stability of the storage device are improved.

In an embodiment of the present disclosure, referring to FIG. 1F, the deep learning algorithm is a learning method operated by a deep neural network, and the learning method operated by the deep neural network includes: inputting the behavior information through an input layer; performing deep learning processing by processing the behavior information of the storage device through at least one intermediate processing layer, including: analyzing features of interested events, taking the analyzed features as parameters of the input layer, generating output parameters by an output layer through a back propagation algorithm, and updating weight values of nodes in the intermediate processing layers; outputting processed output parameters through the output layer, i.e. the behavior parameters of the storage device.

Referring to FIGS. 1D-1G, the present disclosure provides a new algorithm architecture, so that the flash control chip (i.e., the memory controller) may give the control chip the intelligent function of self-learning (i.e. self-optimization) during use through the Deep Neural Network (DNN). The behaviors occurred during the operation of the flash device include: command, data stream, flash memory status, voltage status, temperature status, etc. These behaviors are monitored and filtered by the Meta Event Filter. The filtered event is an Interested Event, which is defined as an event related to intelligent learning.

When occurring, the interested event will be sent to the back propagation algorithm module for processing. The interested events may occur simultaneously or continuously in a very short time. To avoid omission, the event to be processed will be retained in the event queue. The interested events are classified first, and are analyzed sequentially or simultaneously according to the categories. This embodiment divides the interested events into command execution, data stream, abnormal power failure, flash abnormality, and voltage/temperature abnormality according to the event type. The command execution contains the commands issued by the Host. The data stream includes events related to the data/data transfer time, such as the usage status of the buffer, the transfer rate of the host, the data transfer timing, the data error detection status, and the like. Abnormal power outages include any events related to power management, such as no early warning power outages, early warning power outages, etc. Flash exceptions include events related to flash memory operation exceptions, such as read errors, write failures, block erase failures, reread behaviors, error correction behaviors, operation timeouts, etc. Voltage/temperature anomalies include anomalies related to voltage levels or temperatures.

The algorithm analyzes the features of the interested events, and uses the analyzed features as the parameters (X0, X1, X2, Xn) of the input layer of the DNN. After processed by the back propagation algorithm, the output parameters (Y0, Y1, Y2, Ym) are generated by the output layer, and W in each hidden layer node of the DNN itself is updated.

According to the event type, the DNN output parameters processed by the back propagation algorithm are used as the input parameters of each algorithm of the relevant flash control firmware module, and the firmware module will use these parameters as the basis for the policy decision when the host command is executed next time.

According to the present disclosure, a new storage device has a preset DNN before leaving the factory. During the use of the storage device, the control chip will update the DNN according to features obtained from the interested event through back propagation algorithm according to the foregoing embodiment. The intelligent effect of deep learning is achieved through continuous DNN update. The continuously updated DNN is stored in the internal memory (DRAM/SRAM) or external memory (DRAM/SRAM) of the control chip, and will eventually be stored in the flash memory array of the flash device.

The present disclosure proposes two embodiments for writing DNNs from DRAM/SRAM into flash memory. One is immediate update, i.e. the DNN is written to the Flash Memory array immediately after the DRAM/SRAM is updated. The other is delayed update, that is, the DNN is not immediately written to the flash memory array after the DRAM/SRAM is updated, but is written into the flash memory until the number of updates reaches a specified value or the warning power failure occurs.

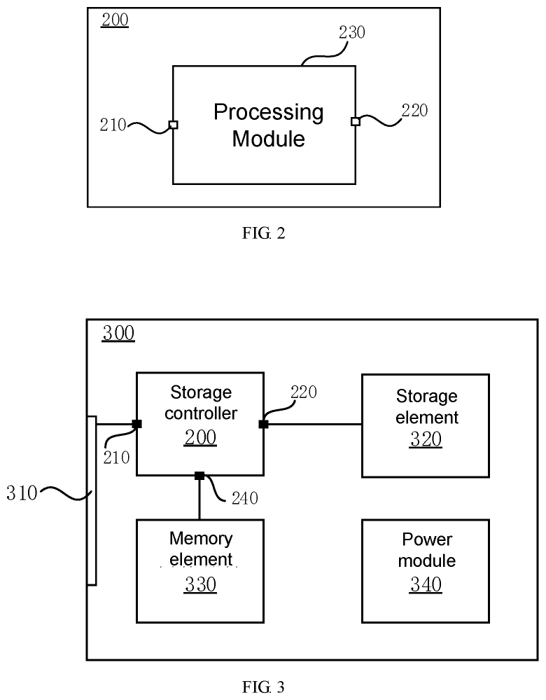

Referring to FIG. 2, an embodiment of the present disclosure further provides a storage controller 200 for controlling storage behavior of a storage device 300. The storage controller 200 includes: a first interface 210, a second interface 220, and a processing module 230. The first interface 210 is in communication connection with the user interface 310 of the storage device 300, and is used to obtain user behavior information of the storage device. The second interface 220 is in communication connection with the storage element 320 of the storage device 300 for acquiring storage element behavior information of the storage device. The processing module 230 is in communication connection with the first interface 310 and the second interface 320, for processing the user behavior information or/and the storage element behavior information by using a deep learning algorithm to obtain the behavior parameter of the storage device, and adjusting an operation mode of the storage device by using the behavior parameter of the storage device. The processing module 230 may execute the storage control method described in the embodiments of the present disclosure.

Further, referring to FIG. 3, the storage controller 200 may further include a third interface 240. The third interface is in communication connection with the internal storage element 330 of the storage device 300 for temporarily storing data required by the deep learning algorithm, and programs or data related to CPU program processing.

In a specific application, taking the NAND flash memory as an example, the function of the processing module 230 can be implemented by the firmware in the NAND flash controller. As shown in FIG. 1D, R/W Oriented is a module in firmware, for processing a read or write command that the Host issues to the flash storage. Ran/Seq Weighting is a module in the firmware that adjusts the weight of random read/write and sequential read/write in the firmware. The function is to obtain the best random/sequential read/write performance. Data Allocator is a module in the firmware that determines the location allocated to each data writing behavior. Metadata Manager is a module in the firmware that manages the flash blocks that store relay data; CMD Scheduling is a module in the firmware that schedules the commands issued by the Host. Buffer Manager is a module in the firmware that manages the allocation of memory blocks from the cache memory. Bus Arbitrator is a module in the firmware that controls the ownership of the bus usage right when data is transferred. Clock Manager is a module in the firmware that manages the operating clock frequency of the main control chip. Garbage Collection is a module in the firmware. It manages the recycling of data blocks marked as garbage in flash memory, and the concentration of scattered data between data blocks. Wear-Leveling is a module in the firmware that manages the allocation of data blocks, so that the number of write/erase times between different data blocks may be averaged. Background OP is a module in the firmware that manages when and which work may be executed in the background. SPOR is a module in the firmware that handles data recovery when an unexpected power outage occurs. Power Manager is a module in the firmware that manages the power state of each hardware module in the main control chip, to reduce power consumption. Read Retry is a module in the firmware that handles the re-reading mechanism when data read from the flash memory cannot be corrected by ECC. ECC Control is a module in the firmware that manages the error correction module in the hardware circuit. Flash Driver is a module in the firmware that manages the execution of commands such as write, read, and erase of the flash memory. Error Handling is a module in the firmware that handles subsequent behaviors after flash write, read, or erase has been executed.

Referring to FIG. 3, an embodiment of the present disclosure further provides a storage device 300. The storage device 300 includes: a user interface 310, at least one storage element 320, at least one internal storage element 330, a power module 340, and a storage controller 200. The user interface 310 is in communication connection with a user device for receiving a storage instruction of the user device. The storage element 320 stores data. The internal storage element 330 temporarily stores operational data. The power module 340 controls power supply. The storage controller 200 is in communication with the user interface 310, at least one storage element 320, at least one internal storage element 330, and the power module 340, respectively. The storage controller 200 includes: a first interface 210, a second interface 220, and a processing module 230. The first interface 210 is in communication with the user interface 310 of the storage device 300, and is used to obtain user behavior information of the storage device. The second interface 220 is in communication connection with the storage element 320 of the storage device 300 for acquiring storage element behavior information of the storage device.

The processing module 230 is in communication connection with the first interface 310 and the second interface 320, and is configured to process the behavior information by using a deep learning algorithm, obtain behavior parameters of the storage device, and use the behavior parameter of the storage device to adjust an operation mode of the storage device. The processing module 230 can execute the storage control method described in the embodiments of the present disclosure.

Further, the storage controller 200 may further include a third interface 240. The third interface 240 is in communication connection with the internal storage element 330 of the storage device 300 for temporarily storing data required by the deep learning algorithm, and programs or data related to CPU program processing.

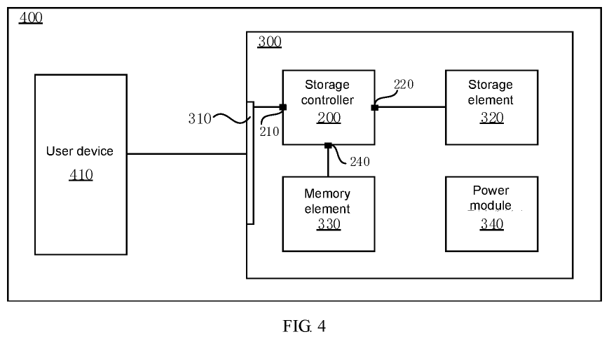

Referring to FIG. 4, an embodiment of the present disclosure further provides a storage system 400, which includes: a user device 410 and a storage device 300. The user device 410 is configured to control a storage device 300 to perform a storage operation. The user device includes a host system. The storage device 300 includes a user interface 310, at least one storage element 320, at least one internal storage element 330, a power module 340, and a storage controller 200. The user interface 310 is in communication connection with a user device for receiving a storage instruction of the user device. The storage element 320 stores data. The power module 340 controls the power supply. The storage controller 200 is in communication connection with the user interface 310, the at least one storage element 320, the at least one internal storage element 330, and the power module 340, respectively. The storage controller 200 includes: a first interface 210, a second interface 220, and a processing module 230. The first interface 210 is in communication connection with the user interface 310 of the storage device 300, and is used to obtain user behavior information of the storage device. The second interface 220 is in communication connection with the storage element 320 of the storage device 300 for acquiring storage element behavior information of the storage device. The processing module 240 is in communication connection with the first interface 310 and the second interface 320 respectively, processing the user behavior information or/and the storage element behavior information through a deep learning algorithm, obtaining an behavior parameter of the storage device, and adjusting an operation mode of the storage device through the behavior parameter of the storage device. The processing module 230 can execute the storage control method described in the embodiments of the present disclosure.

The storage controller 200 may further include a third interface 240. The third interface 240 is in communication connection with the internal storage element 330 of the storage device 300 for temporarily storing data required by the deep learning algorithm, and programs or data related to CPU program processing.

The present disclosure further provides a non-transitory computer-readable storage medium, including a set of instructions that, when executed by a processor, cause the processor to perform a storage control method. The method includes: acquiring behavior information of a storage device; processing the behavior information through a deep learning algorithm to obtain a behavior parameter of the storage device; and adjusting an operation mode of the storage device according to the behavior parameter of the storage device.

Further, the deep learning algorithm is a learning method operated by a deep neural network, and includes: inputting the behavior information through an input layer; performing deep learning processing by processing the behavior information of the storage device through at least one intermediate layer, including: analyzing features of interested events, taking the analyzed features as parameters of the input layer, generating output parameters by an output layer through a back propagation algorithm, and updating weight values of nodes of the intermediate layers; outputting processed output parameters through the output layer.

The present disclosure may find a corresponding firmware processing manner suitable for the access behavior of the system to the storage device through the self-learning method (i.e., the deep learning algorithm) during system operation, thereby achieving the purpose of improving the overall data access performance of the system.

The present disclosure may adjust the management mechanism of the power management module and the data security protection module in the firmware according to the observation of the system power behavior through the self-learning method during system operation, thereby realizing the optimal mode for the operation of the overall system power supply, and improving the reliability and stability of the overall system (i.e. the user device and the storage device).

The present disclosure may adjust the management mechanism of the driver module of the storage device in the firmware according to the internal storage behavior analysis of the storage device through the self-learning method during system operation, thereby realizing the optimal control mode of the memory chip in the storage device (such as the NAND flash memory, DRAM, etc.), and improving the reliability and stability of the storage device.

The present disclosure may completely solve the problem that the storage device must be customized according to various system environment requirements.

In summary, the present disclosure effectively overcomes various shortcomings and has high industrial utilization value.

The above-mentioned embodiments are just used for exemplarily describing the principle and effects of the present disclosure instead of limiting the present disclosure. Those skilled in the art can make modifications or changes to the above-mentioned embodiments without going against the spirit and the range of the present disclosure. Therefore, all equivalent modifications or changes made by those who have common knowledge in the art without departing from the spirit and technical concept disclosed by the present disclosure shall be still covered by the claims of the present disclosure.

We claim:

1. A storage control method, for controlling a storage behavior of a storage device, wherein the storage control method comprises:
acquiring behavior information of the storage device;
obtaining a behavior parameter of the storage device by processing the behavior information through a deep learning algorithm; and
adjusting an operation mode of the storage device according to the behavior parameter of the storage device.

2. The storage control method according to claim 1, wherein the behavior information of the storage device comprises user behavior information; a user of the storage device is a host system, and the user behavior information of the storage device comprises:
an instruction set sequence issued by the host system to the storage device;
a read data amount, a read position, and a read range performed by the host system on the storage device;
a write data amount, a write position, and a write range performed by the host system on the storage device; or/and
a data stream behavior when the host system performs writing and reading data on the storage device, wherein the data stream behavior comprises:
a busy time for transferring data, and an idle time for suspending data transfer of a data bus of the host system, and
a busy time and an idle time of a data bus of a storage element.

3. The storage control method according to claim 2, wherein obtaining a user behavior parameter of the storage device by processing the user behavior information through the deep learning algorithm comprises:
processing the instruction set sequence by using the deep learning algorithm to obtain a command set and a command sequence commonly used in the host system;
processing the read position through the deep learning algorithm to obtain a ratio of sequential read commonly used in the host system to random read;
processing the write position through the deep learning algorithm to obtain a ratio of sequential write commonly used in the host system to random write;
processing the write data amount and the read data amount through the deep learning algorithm to obtain a data write/read amount statistics table commonly used in the host system;
processing the write position and the read position through the deep learning algorithm to obtain a data write/read start logical position statistics table commonly used in the host system;
processing the write range and the read range through the deep learning algorithm to obtain a data write/read range statistics table commonly used in the host system;
processing the data stream behavior through the deep learning algorithm when writing and reading data, to obtain a data stream behavior statistics table commonly used in the host system.

4. The storage control method according to claim 3, wherein the user behavior parameter of the storage device comprises:
the command set and the command sequence commonly used in the host system;
the ratio of sequential read commonly used in the host system to random read;
the ratio of sequential write to random write commonly used in the host system;
the data write/read amount statistics table commonly used in the host system;
the data write/read start logical position statistics table commonly used in the host system;
the data write/read range statistics table commonly used in the host system; or/and
the data stream behavior statistics table commonly used in the host system.

5. The storage control method according to claim 4, wherein adjusting the operating mode of the storage device according to the user behavior parameter of the storage device comprises:
the storage device includes a storage controller and the storage element;
adjusting a data write/read management strategy for the storage device;
adjusting an allocation strategy of a data/control signal bus usage right;
adjusting an allocation and placement strategy of a data block in the storage element;
adjusting a command processing priority strategy;
adjusting a management strategy for data buffer;
adjusting a writing or reading rate to the storage element;
adjusting an operating frequency of the storage controller;
adjusting a start timing and a behavior decision of a background operation; or/and
adjusting a power management start timing and mode.

6. The storage control method according to claim 1, wherein
a user of the storage device is a host system;
the behavior information of the storage device comprises system power behavior information, the system power behavior information comprises a power supply voltage, a power management mode, a power-off behavior, and power stability of the storage device performed by the host system.

7. The storage control method according to claim 6, wherein processing the system power behavior information though the deep learning algorithm to obtain a system power behavior parameter of the storage device comprises:
processing the power supply voltage through the deep learning algorithm to obtain a voltage range;
processing the power management mode through the deep learning algorithm to obtain a sleep mode statistics table; and
processing the power-off behavior through the deep learning algorithm to obtain a safe power-off program mode and an unsafe power-off statistic;
wherein the system power behavior parameter comprises:
the voltage range,
the sleep mode statistics table,
the safe power-off program mode, or/and
the unsafe power-off statistic.

8. The storage control method according to claim 7, wherein adjusting the operating mode of the storage device according to the system power behavior parameter comprises:
adjusting a management mechanism of power management and data security protection of the storage device;
adjusting a start timing and a behavior decision of a background operation; or/and
adjusting a data buffer mechanism and a final storage block configuration decision of the storage element.

9. The storage control method according to claim 1, wherein a user of the storage device is a host system; the behavior information of the storage device comprises working environment temperature behavior information, the working environment temperature behavior information comprises: a working environment temperature of the storage device when executing a command of the host system; the method comprises:
processing the working environment temperature behavior information through a deep learning algorithm to obtain a working environment temperature behavior parameter of the storage device.

10. The storage control method according to claim 9, wherein adjusting the operating mode of the storage device according to the working environment temperature behavior parameter comprises:
adjusting a power management mechanism of the storage device;
adjusting a writing or reading rate to the storage element;
adjusting an operating frequency of the storage controller;
adjusting a start timing and a behavior decision of a background operation; or/and
adjusting a power management start timing and mode.

11. The storage control method according to claim 1, wherein the behavior information of the storage device comprises storage element behavior information, the storage element behavior information comprises:
a number of an error code and probability of error code occurrence of a read block position of the storage device when reading data;
a behavior mode of hard decoding and soft decoding when the error code of the read block position of the storage device occurs when reading data;
a probability of rereading data and a success probability of parameters in a rereading table of the storage element when reading data;
a writing failure rate of a write block position of the storage device when writing data;
an erasing failure rate of an erase block position of the storage device when deleting data;
timing of a control signal and a data signal when data is written to the storage element, wherein the timing comprises a clock rate, a slew rate, and a delay time;
timing of the control signal and the data signal when reading data of the storage element, wherein the timing comprises a clock rate, a slew rate, and a delay time; or/and
an operating voltage of the storage element.

12. The storage control method according to claim 11, wherein processing the storage element behavior information through the deep learning algorithm to obtain a storage element behavior parameter comprises:
processing the storage element behavior information through the deep learning algorithm to obtain an optimal timing of the control signal and the data signal when the data is written into the storage element, the optimal timing comprises a clock rate, a slew rate, and a delay time;
processing the storage element behavior information through the deep learning algorithm to obtain an optimal timing of the control signal and the data signal when reading data of the storage element, the optimal timing comprises a clock rate, a slew rate, and a delay time;
processing the storage element behavior information through the deep learning algorithm to obtain an optimal swing level of the control signal and the data signal; and
processing the writing failure rate, the erasing failure rate, the probability of rereading the table, and the number of the error code and probability of the error code occurrence through the deep learning algorithm, to obtain a storage block health status statistics table in the storage element.

13. The storage control method according to claim 12, wherein the storage element behavior parameter of the storage device comprises:
the optimal timing of the control signal and the data signal when the data is written into the storage element;
the optimal timing of the control signal and the data signal when reading the storage element;
the optimal swing level of the control signal and the data signal; or/and
the storage block health status statistics table in the storage element.

14. The storage control method according to claim 13, wherein adjusting the operating mode of the storage device according to the storage element behavior parameter of the storage device comprises:
adjusting a driving management mechanism for the storage element in the storage device according to the storage element behavior parameter of the storage device;
adjusting a data write/read management mechanism for the storage device;
adjusting a data block allocation and placement strategy of the storage element;
adjusting a management strategy for data buffer;
adjusting a writing or reading rate to the storage element; or/and
adjusting a start timing and a behavior decision of a background operation.

15. The storage control method according to claim 1, wherein the deep learning algorithm is a learning method operated by a deep neural network, and the learning method operated by the deep neural network comprises:
inputting the behavior information through an input layer;
performing deep learning processing by processing the behavior information of the storage device through at least one intermediate processing layer, including:
analyzing features of interested events,
taking the analyzed features as parameters of the input layer,
generating output parameters by an output layer through a back propagation algorithm, and
updating weight values of nodes in the intermediate processing layers; and
outputting processed output parameters through the output layer.

16. A storage controller, for controlling a storage behavior of a storage device, wherein the storage controller comprises:
a first interface in communication connection with a user interface of the storage device, for acquiring user behavior information of the storage device;
a second interface in communication connection with a storage element of the storage device, for acquiring storage element behavior information of the storage device; and
a processing module in communication connection with the first interface and the second interface respectively, for processing behavior information of the storage device through a deep learning algorithm, obtaining a behavior parameter of the storage device, and adjusting an operation mode of the storage device through the behavior parameter of the storage device.

17. A storage device, comprising:
a user interface in communication connection with a user device, for receiving a storage instruction of the user device;
at least one storage element for storing data;
a power module for supplying power; and
a storage controller in communication connection with the user interface, the storage element, and the power module respectively, wherein the storage controller includes:
a first interface in communication connection with the user interface, for acquiring user behavior information of the storage device;
a second interface in communication connection with the storage element, for acquiring storage element behavior information of the storage device; and
a processing module in communication connection with the first interface and the second interface respectively, for processing behavior information of the storage device through a deep learning algorithm, obtaining a behavior parameter of the storage device, and adjusting an operation mode of the storage device through the behavior parameter of the storage device.

18. A storage system, comprising:
a user device, for controlling a storage device to perform a storage operation, the user device comprises a host system, wherein the storage device comprises:
a user interface in communication connection with the user device, for receiving a storage instruction of the user device;
at least one storage element for storing data;
a power module for supplying power; and
a storage controller in communication connection with the user interface, the storage element, and the power module respectively, wherein the storage controller includes:
a first interface in communication connection with the user interface, for acquiring user behavior information of the storage device,
a second interface in communication connection with the storage element, for acquiring storage element behavior information of the storage device, and
a processing module in communication connection with the first interface and the second interface respectively, for processing behavior information of the storage device through a deep learning algorithm, obtaining a behavior parameter of the storage device, and adjusting an operation mode of the storage device through the behavior parameter of the storage device.

19. A non-transitory computer-readable storage medium, comprising a set of instructions that, when executed by a processor, cause the processor to perform a storage control method, the method comprising:
obtaining behavior information of a storage device;
processing the behavior information through a deep learning algorithm to obtain a behavior parameter of the storage device; and
adjusting an operation mode of the storage device according to the behavior parameter of the storage device.

20. The non-transitory computer-readable storage medium according to claim 19, wherein the deep learning algorithm includes a learning method operated by a deep neural network, and comprises:
inputting the behavior information using an input layer;
performing deep learning processing by processing the behavior information of the storage device through at least one intermediate processing layer, including:
analyzing features of interested events,
taking the analyzed features as parameters of the input layer,
generating output parameters by an output layer through a back propagation algorithm, and
updating weight values of nodes in the intermediate processing layers; and
outputting processed output parameters through the output layer.
